(19) United States
(12) Patent Application Publication
(10) Pub. No.: US 2012/0300457 A1
(43) Pub. Date: Nov. 29, 2012

(54) LIGHT-EMITTING DEVICE

(75) Inventors: Young Sik Jeong, Seoul (KR); No Jun Kwak, Suwon (KR); Chang Ho Shin, Incheon (KR)

(73) Assignee: SAMSUNG ELECTRONICS CO., LTD., Suwon-si (KR)

(21) Appl. No.: 13/522,473

(22) PCT Filed: Jan. 14, 2011
(86) PCT No.: PCT/KR2011/000296

§ 371 Date: Jul. 16, 2012

(30) Foreign Application Priority Data
Jan. 15, 2010 (KR) PCT KR2010 000251

(51) Int. Cl. F21V 21/00

(52) U.S. Cl. 362/249.01

(57) ABSTRACT

There is provided a light-emitting device including a substrate body, a winding pattern unit including a plurality of mounting parts formed as conductive thin films covering a portion of an upper surface of the substrate body and spaced apart from one another and a connection line formed to have a width narrower than that of each of the mounting parts so as to electrically connect the plurality of mounting parts and light sources, at least one light source being disposed on at least one of the plurality of mounting parts.

### TECHNICAL FIELD

The present invention relates to a light-emitting device.

### BACKGROUND ART

Printed circuit boards (PCBs), used for mounting light-emitting devices, are components serving to simply connect various electronic elements according to a certain structure and widely used in all electronic products, from home appliances including digital TVs to advanced communications equipment, and may be classified as a general PCB, a module PCB, a package PCB or the like.

PCBs formed by attaching a copper sheet or the like to a surface of an FR-4 sheet or the like, performing etching on the copper sheet according to a circuit wiring pattern to configure a required circuit, and then mounting components thereon, may be classified as a single-sided substrate, a double-sided substrate, a multilayer substrate, or the like.

Among these substrates, the double-sided substrate may be formed by laminating sheets of copper foil onto two surfaces of an FR-4 sheet and connecting the two surfaces through a via hole, while the process may be extended to a plurality of layers as well as the two surfaces, in the case of the multilayer substrate.

However, raw materials used in the manufacturing of a double-sided substrate or a multilayer substrate may be relatively expensive, and a large number of manufacturing processes may be required therefor, as compared to the case of a single-sided substrate having a copper coil laminated on a surface thereof, thereby leading to increases in manufacturing costs. In addition, there may be concern with regard to deterioration in the quality of the double sided-substrate or the multilayer substrate, due to defects caused by the via hole.

Thus, it may be advantageous to use the single-sided substrate in order to improve manufacturing costs and a deterioration in quality due to via hole defects.

In a single-sided PCB according to the related art, the entirety of one surface of the board is occupied by a sheet of copper foil at the time of the designing of the substrate. However, since the single-sided PCB according to the related art has a large area occupied by the copper foil, a significant difference in thermal expansion between a copper formation surface and a non-copper formation surface may be generated in a reflow process in surface mounting technology (SMT), thereby causing a warpage phenomenon in the board, such as warping or twisting, after the reflow process.

In addition, defects due to the warpage phenomenon in the board may occur when various components, such as an LED chip and the like are mounted on a surface of the board.

### DISCLOSURE

### Technical Problem

An aspect of the present invention provides a light-emitting device capable of significantly reducing a warpage phenomenon in a circuit board generated in a process such as a reflow process or the like by decreasing an area occupied by a conductive thin film in the circuit board on which a light source is mounted.

### Technical Solution

According to an aspect of the present invention, there is provided a light-emitting device, including: a substrate body; a winding pattern unit including a plurality of mounting parts formed as conductive thin films covering a portion of an upper surface of the substrate body and spaced apart from one another and a connection line formed to have a width narrower than that of each of the mounting parts so as to electrically connect the plurality of mounting parts; and light sources, wherein at least one light source is disposed on at least one of the plurality of mounting parts.

The plurality of mounting parts may be disposed in rows and columns.

Mounting parts in adjacent rows among the plurality of mounting parts may be alternately disposed in a column direction.

At least a part of the connection line may be bent.

Each of the mounting parts may have a rectangular appearance when viewed from above.

An area occupied by the plurality of mounting parts in the upper surface of the substrate body may be 50% to 80% with respect to an area of the upper surface of the substrate body.

The substrate body may be formed of a flexible material.

The substrate body may be formed of an electrically insulating material.

At least one of the plurality of mounting parts may have first and second pad parts separated from each other.

An area occupied by the first pad part in the upper surface of the substrate body may be greater than that of the second pad part.

An area occupied by the first pad part in the upper surface of the substrate body may be greater than an area occupied by the second pad part.

Each of the light sources may include first and second terminals contacting the first and second pad parts and a light emitting element disposed on the first terminal.

The first pad part may have a region inwardly recessed from a side thereof towards a center thereof, and the second pad part may be disposed within the recessed region of the first pad part.

The mounting parts and the connection line may be formed of the same material.

The connection line may include a part thereof electrically connecting the plurality of mounting parts in series and a part thereof electrically connecting the plurality of mounting parts in parallel.

The light-emitting device may further include a protection part formed to cover at least portions of the upper surface of the substrate body and an upper surface of the mounting parts, and formed of an electrically insulating material.

The protection part may be formed to cover an upper surface of the connection line.

The protection part may be formed of a material reflecting light emitted from the light sources.

The protection part may be formed of a photo solder resist (PSR).

At least one of the plurality of mounting parts may include a test point not covered by the protection part to be outwardly exposed, in addition to a mounting region of the light source.

The light-emitting device may further include one or more stress dispersion holes formed to penetrate the substrate body in a thickness direction.

The stress dispersion holes may be formed in edge regions of the substrate body.

The stress dispersion holes may be formed in a center region of the substrate body.

The stress dispersion holes may be formed in edge regions of the mounting parts.

### Advantageous Effects

a light-emitting device capable of significantly reducing a warpage phenomenon in a circuit board generated in a process such as a reflow process or the like by decreasing an area occupied by a conductive thin film in the circuit board on which a light source is mounted can be obtained.

### DESCRIPTION OF DRAWINGS

FIG. 1 is a schematic plan view illustrating a light-emitting device according to an embodiment of the present invention;

FIG. 2 is a schematic plan view illustrating a substrate part except for a light source in the light-emitting device of FIG. 1;

FIG. 3 is a schematic cut away, cross-sectional view taken along part A-A′ of FIG. 2;

FIG. 4 is a schematic cut away, cross-sectional view taken along part B-B′ of FIG. 1;

FIG. 5 is a schematic view illustrating a shape of a mounting part capable of being employed in another embodiment of the present invention;

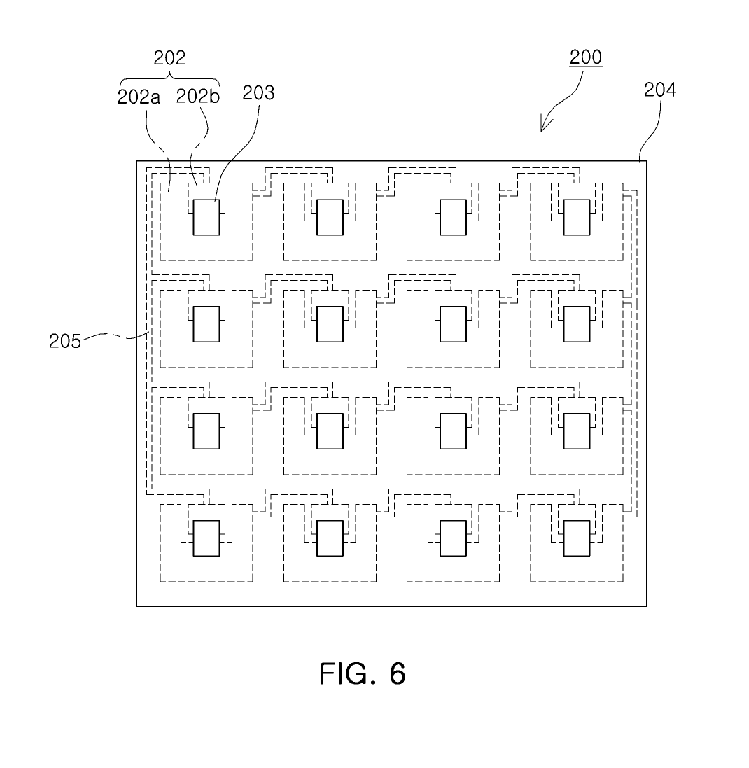

FIG. 6 is a schematic plan view illustrating a light-emitting device according to another embodiment of the present invention; and

FIGS. 7 and 8 are schematic plan views each illustrating a light-emitting device according to another embodiment of the present invention.

### BEST MODE

A backlight unit according to embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Thus, the shapes and sizes of components shown in the drawings are exaggerated for clarity. Elements having substantially the same or equivalent constitutions and functions are referred to by the same reference numerals throughout the specification.

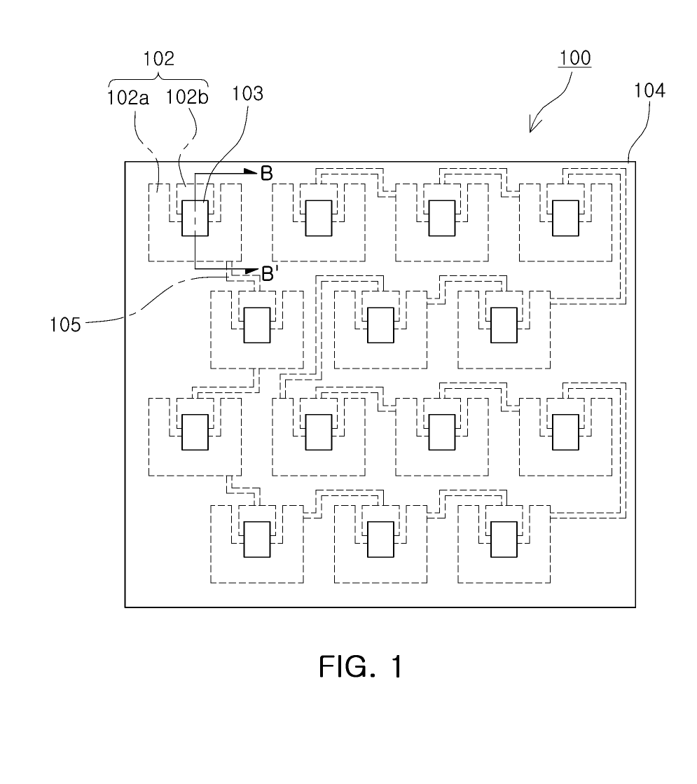

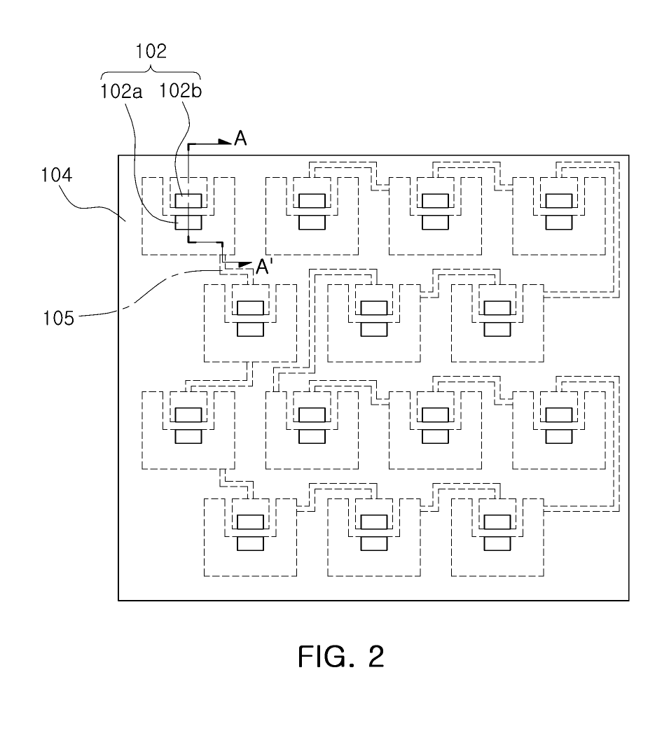

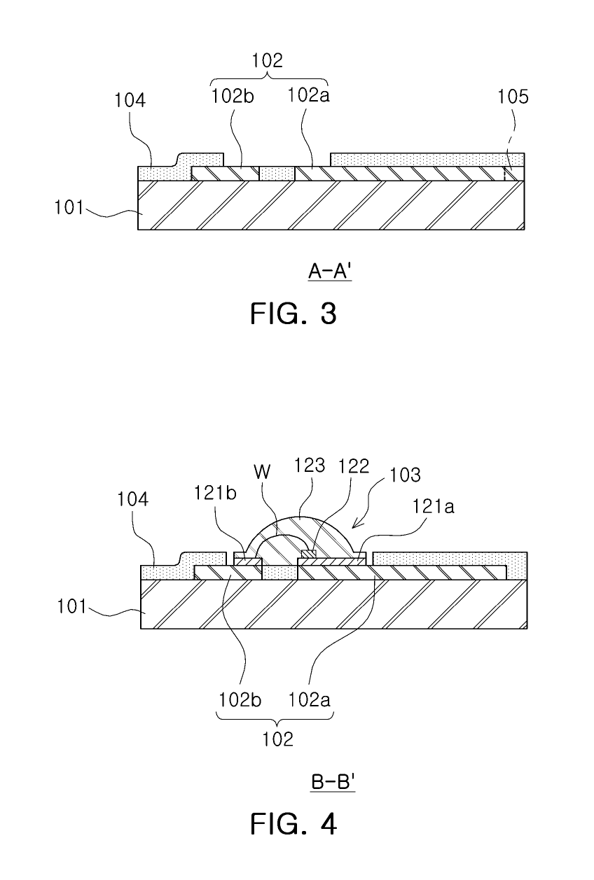

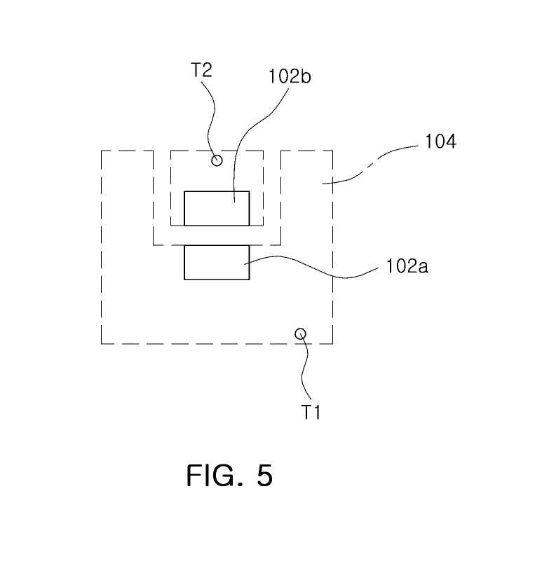

FIG. 1 is a schematic plan view illustrating a light-emitting device according to an embodiment of the present invention. FIG. 2 is a schematic plan view illustrating a substrate except for a light source in the light-emitting device of FIG. 1. FIG. 3 is a schematic cut away, cross-sectional view taken along part A-A′ of FIG. 2. FIG. 4 is a schematic cut away, cross-sectional view taken along part B-B′ of FIG. 1.

Referring to FIGS. 1 through 4, a light-emitting device 100 according to the embodiment of the present invention may include a substrate body 101, a plurality of mounting parts 102, light sources 103, and a protection part 104. The respective components will be explained below. First, the substrate body 101 corresponds to a base region configuring a circuit board for mounting the light sources 103, and may be formed of a flexible material, for example, a material such as FR-4, CEM-3, or the like. However, a material of the substrate body 101 is not limited thereto, and may also be formed of a glass or epoxy material, a ceramic material, or the like. In addition, the substrate body 101 may be formed of an electrically insulating material, in that it comes into contact with first and second pad parts 102a and 102b corresponding to conductive patterns; however, for example, the substrate body 101 may have a structure in which an insulating layer is formed on an upper surface of a metal base.

Each of the mounting parts 102 may be provided to mount each light source 103 thereon and include the first and second pad parts 102a and 102b to be electrically connected to the light source 103. In this case, the first and second pad parts 102a and 102b of the mounting part 102 may be formed as conductive thin films, for example, be formed of sheets of copper foil. In the embodiment of the present invention, the plurality of mounting parts 102 may be spaced apart from one another and electrically connected to one another via a connection line 105, as can be seen in FIG. 1. In this case, the connection line 105 may have a width narrower than that of each mounting part 102 and be formed of the same material as that of the mounting parts 102, for example, a sheet of copper foil. In addition, the connection line 105 may be bent as necessary in order to connect the mounting parts 102 spaced apart from one another. In the embodiment, the light sources 103 may be provided in plural and the plurality of light sources 103 may be connected to one another in series. However, the light sources 103 may be connected to one another in parallel or connected in series and parallel configurations according to embodiments. In addition, even though the light sources 103 may be connected in the same electrical method, the form of the connection line 105 may be variously modified. In this manner, the mounting parts 102 and the connection line 105 may form a winding pattern unit in the light-emitting device 100, and the winding pattern unit may further include a portion for receiving an external electrical signal applied thereto.

As can be seen in FIGS. 1 and 2, each of the plurality of mounting parts 102 may have a rectangular appearance when viewed from above and be formed to cover only a portion of an upper surface of the substrate body 101. In addition, the plurality of mounting parts 102 may be disposed in rows and columns, and in this case, the mounting parts 102 in adjacent rows among the plurality of mounting parts 102 may be alternately disposed in a column direction, that is, may be disposed in a zigzag manner downwardly in the column direction. In the embodiment of the present invention, an area occupied by the plurality of mounting parts 102 (hereinafter, referred to as an ‘area of the mounting parts 102’) in the upper surface of the substrate body 101 may be relatively small, such that thermal stress caused by a difference in a coefficient of thermal expansion between the mounting parts 102 and the substrate body 101 may decrease. In the case of a decrease in thermal stress, a warpage phenomenon capable of occurring in the substrate body 101, such as warping, twisting or the like, may be improved.

The mounting parts 102 may be formed by forming a sheet of copper foil or the like on the entire surface of the substrate body 101 and then removing a partial region of the surface through a method such as etching or the like, in order to allow the mounting parts 102 to only cover a portion of the upper surface of the substrate body 101. Considering that an area occupied by a copper foil in a general PCB is 90% or greater, the area of the mounting parts 102 in the upper surface of the substrate body 101 may be approximately 50% to 80% with respect to an area of the upper surface of the substrate body 101. When a ratio of the area of the mounting parts 102 with respect to the area of the upper surface of the substrate body 101 is greater than 80%, it may be difficult to sufficiently realize functions capable of relieving warping, while when a ratio of the area of the mounting parts 102 with respect to the area of the upper surface of the substrate body 101 is smaller than 50%, there may be concern about deterioration in electrical performance or heat radiation performance.

As the light source 103, any light source may be used as long as it may emit light at the time of applying an electrical signal thereto, and for example, may be provided as a package including a light emitting diode or may merely be provided as the light emitting diode (for example, a COB type light source). In this case, one light source 103 may be mounted on each of the mounting parts 102, as in the embodiment of the present invention. However, two or more light sources 103 may be mounted on each of the mounting parts 102 in another embodiment. In this case, the plurality of light sources 103 may be electrically connected to one another in series, in parallel, or in series and parallel configurations according to a design of the connection line 105.

As shown in FIG. 4, each light source 103 may be provided as a package including a light emitting element 122, and FIG. 4 illustrates an example of a package. Specifically, the light source 103 may include first and second terminals 121a and 121b, and the light emitting element 122 may be disposed on the first terminal 121a. The light emitting element 122 may be electrically connected to the first and second terminals 121a and 121b, and to this end, a conductive wire W may be required. A package body 123 may seal and protect the light emitting element 122, the conductive wire W, and the like, and allow the first and second terminals 121a and 121b to be fixed therein. In addition, the package body 123 may be formed of a light-transmitting substance and an upper part of the light emitting element 122 may be provided to have a lens shape. In addition to a package having the structure, a variety of packages known in the related art, for example, a package including a package body provided having a reflective cup shape may be employed.

Meanwhile, as illustrated in FIG. 4, the first and second terminals 121a and 121b of the light source 103 are disposed to contact the first and second pads 102a and 102b, respectively. The first and second pad parts 102a and 102b may have different sizes in consideration of heat radiation aspects. In other words, the size of the first pad part 102a contacting the first terminal 121a on which the light emitting element 122 corresponding to a heat source is disposed may be relatively larger than that of the second pad part 102b, that is, an area occupied by the first pad part 102a in the upper surface of substrate body 101 may be greater than that of the second pad part 102b, in terms of heat radiation reliability. In order to satisfy the size conditions, the first pad part 102a may be inwardly recessed from a side thereof toward a center thereof and the second pad part 102b may be disposed within the recessed region, as illustrated in FIG. 2. In this case, shapes of the first and second pad parts 102a and 102b may be variously modified within an area range capable of decreasing board warpage, according to a structure of the light source 103.

As illustrated in FIGS. 3 and 4, the protection part 104 may be formed to cover portions of the upper surface of the substrate body 101 and an upper surface of the mounting part 102, and the connection line 105. The protection part 104 may be formed of an electrical insulating material to thereby serve to passivate the light-emitting device 100. In addition, the protection part 104 may be formed of a material having high reflectance with respect to light emitted from the light source 103 in an aspect of light emitting efficiency. A material suitable for the passivation and reflection functions may be a photo solder resist (PSR), for example. Meanwhile, the protection part 104 may be formed except for a mounting area of the light source 103. In addition to the mounting area of the light source 103, the protection part 104 may not be formed on partial regions of the first and second pad parts 102a and 102b of the mounting part 102 to expose the regions, and these exposed regions may be used as test points T1 and T2. By using the test points T1 and T2, it may be easily determined whether each light source 103 is defective or not, even though an electrical signal is not applied to all light sources 103 of the light-emitting device 100.

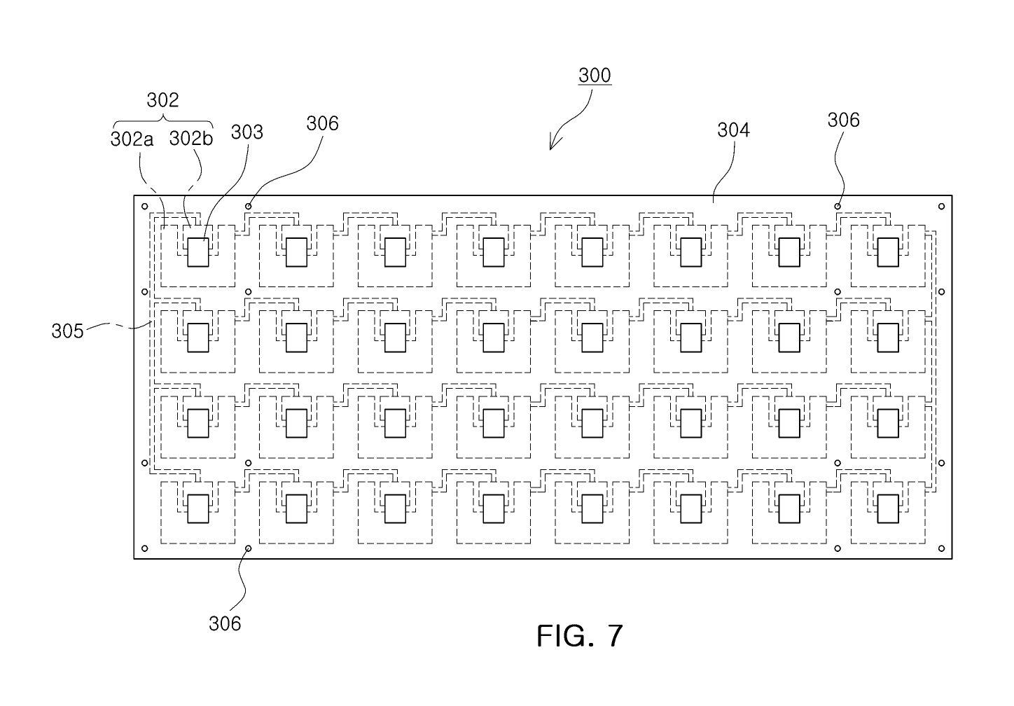

FIG. 6 is a schematic plan view illustrating a light-emitting device according to another embodiment of the present invention. Referring to FIG. 6, a light-emitting device 200 may include a substrate body (not indicated in FIG. 6), a plurality of mounting parts 202, light sources 203, a protection part 204, and a connection line 205, similar to the foregoing embodiment of the present invention. Each mounting part 202 may include first and second pad parts 202a and 202b. The embodiment is different from the foregoing embodiment, in that the plurality of mounting parts 202 are disposed in rows and columns, but not alternately disposed in a column direction, and the connection line 205 has a different shape from that of the foregoing embodiment. Specifically, the light sources 203 may be connected in series and parallel configurations via the connection line 205 (four light sources connected in series are connected in parallel to another four light sources connected in series) in the embodiment of the present invention. Thus, the shape of the connection line 205 may be appropriately modified, while the light sources 203 may be connected in the same manner as above.

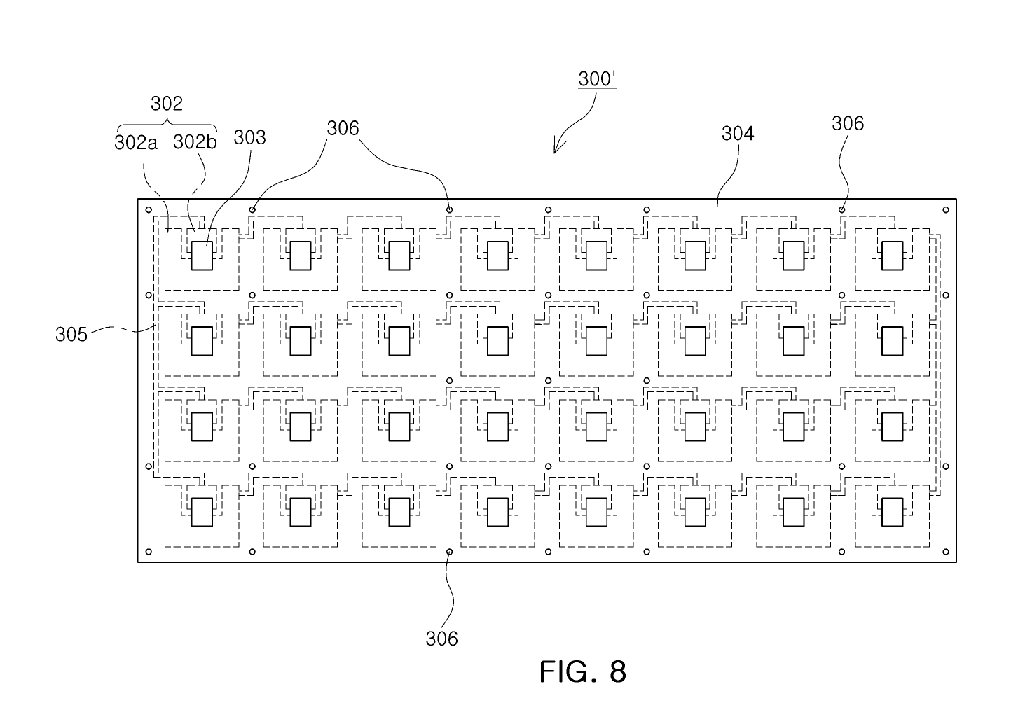

FIGS. 7 and 8 are schematic plan views each illustrating a light-emitting device according to another embodiment of the present invention. Referring to FIG. 7, a light-emitting device 300 may include a substrate body (not indicated in FIG. 7), a plurality of mounting parts 302, light sources 303, a protection part 304, and a connection line 305, similar to the foregoing embodiments of the present invention. Each mounting part 302 may include first and second pad parts 302a and 302b. The embodiment is different from the foregoing embodiments, in that stress dispersion holes 306 are formed in the substrate body in a thickness direction. As illustrated in FIG. 7, the stress dispersion holes 306 may be formed in edge regions of the substrate body. Further, the stress dispersion holes 306 may be formed in a non-winding pattern formation region in edges of the mounting parts 302, so as to surround the mounting parts 302. Since the stress dispersion holes 306 are provided in the substrate body, stress due to heat generated in an operating process of the light sources 103 may not be entirely transferred to the substrate body and may be immobile in, or released from, the stress dispersion holes 306. Thus, a warpage phenomenon in the substrate body due to temperature changes may be prevented by forming the stress dispersion holes 306 in the substrate body. Meanwhile, if necessary, in addition to the edge regions of the substrate body, the stress dispersion holes 306 may also be formed in the center region of the substrate body, as in a light-emitting device 300′ according to a modified embodiment shown in FIG. 8.

While the present invention has been shown and described in connection with the exemplary embodiments, it will be apparent to those skilled in the art that modifications and variations can be made without departing from the spirit and scope of the invention as defined by the appended claims.

1. A light-emitting device, comprising:
a substrate body;
a winding pattern unit including a plurality of mounting parts formed as conductive thin films covering a portion of an upper surface of the substrate body and spaced apart from one another and a connection line formed to have a width narrower than that of each of the mounting parts so as to electrically connect the plurality of mounting parts; and
light sources, wherein at least one light source is disposed on at least one of the plurality of mounting parts.

2. The light-emitting device of claim 1, wherein the plurality of mounting parts are disposed in rows and columns.

3. The light-emitting device of claim 1, wherein mounting parts in adjacent rows among the plurality of mounting parts are alternately disposed in a column direction.

4. The light-emitting device of claim 1, wherein at least a part of the connection line is bent.

5. The light-emitting device of claim 1, wherein each of the mounting parts has a rectangular appearance when viewed from above.

6. The light-emitting device of claim 1, wherein an area occupied by the plurality of mounting parts in the upper surface of the substrate body is 50% to 80% with respect to an area of the upper surface of the substrate body.

7. The light-emitting device of claim 1, wherein the substrate body is formed of a flexible material.

8. The light-emitting device of claim 1, wherein the substrate body is formed of an electrically insulating material.

9. The light-emitting device of claim 1, wherein at least one of the plurality of mounting parts has first and second pad parts separated from each other.

10. The light-emitting device of claim 9, wherein an area occupied by the first pad part in the upper surface of the substrate body is greater than an area occupied by the second pad part.

11. The light-emitting device of claim 10, wherein each of the light sources includes first and second terminals contacting the first and second pad parts and a light emitting element disposed on the first terminal.

12. The light-emitting device of claim 10, wherein the first pad part has a region inwardly recessed from a side thereof towards a center thereof, and the second pad part is disposed within the recessed region of the first pad part.

13. The light-emitting device of claim 1, wherein the mounting parts and the connection line are formed of the same material.

14. The light-emitting device of claim 1, wherein the connection line includes a part thereof electrically connecting the plurality of mounting parts in series and a part thereof electrically connecting the plurality of mounting parts in parallel.

15. The light-emitting device of claim 1, further comprising a protection part formed to cover at least portions of the upper surface of the substrate body and an upper surface of the mounting parts, and formed of an electrically insulating material.

16. The light-emitting device of claim 15, wherein the protection part is formed to cover an upper surface of the connection line.

17. The light-emitting device of claim 15, wherein the protection part is formed of a material reflecting light emitted from the light sources.

18. The light-emitting device of claim 15, wherein the protection part is formed of a photo solder resist (PSR).

19. The light-emitting device of claim 15, wherein at least one of the plurality of mounting parts includes a test point not covered by the protection part to be outwardly exposed, in addition to a mounting region of the light source.

20. The light-emitting device of claim 15, further comprising one or more stress dispersion holes formed to penetrate the substrate body in a thickness direction.

21. The light-emitting device of claim 20, wherein the stress dispersion holes are formed in edge regions of the substrate body.

22. The light-emitting device of claim 20, wherein the stress dispersion holes are formed in a center region of the substrate body.

23. The light-emitting device of claim 20, wherein the stress dispersion holes are formed in edge regions of the mounting parts.
